(19) United States
(12) Patent Application Publication
(10) Pub. No.: US 2024/0310663 A1
(43) Pub. Date: Sep. 19, 2024

(54) OPTICAL WAVEGUIDE ELEMENT, OPTICAL MODULATION DEVICE USING THE SAME, AND OPTICAL TRANSMITTER

(71) Applicant: SUMITOMO OSAKA CEMENT CO., LTD., Tokyo (JP)

(72) Inventors: Yuki KUGIMOTO, Tokyo (JP); Yu KATAOKA, Tokyo (JP); Shingo TAKANO, Tokyo (JP)

(73) Assignee: SUMITOMO OSAKA CEMENT CO., LTD., Tokyo (JP)

(21) Appl. No.: 18/268,070

(22) PCT Filed: Dec. 22, 2021
(86) PCT No.: PCT/JP2021/047501

§ 371 Date: Jun. 16, 2023

(30) Foreign Application Priority Data
Dec. 23, 2020 (JP) 2020-213293

(51) Int. Cl. G02F 1/035

(52) U.S. Cl. CPC G02F 1/035; G02F 2201/063

(57) ABSTRACT

Provided is an optical waveguide element that can suppress insertion loss related to coupling to an optical fiber or the like while achieving a reduction in size of an optical waveguide element, and has a SSC structure with high light resistance, heat resistance, or manufacturing efficiency. An optical waveguide element includes an optical waveguide substrate 1 having a rib-type optical waveguide 10 formed of a material having an electro-optic effect, and a holding member 2 that is disposed and fixed at a position where an input end or an output end of the rib-type optical waveguide is formed, to overlap the optical waveguide substrate, in which another optical waveguide 20 with a mode field diameter greater than that of the rib-type optical waveguide is formed on a surface of the holding member facing the rib-type optical waveguide, and the optical waveguide substrate and the holding member are bonded through an adhesive layer 30.

### TECHNICAL FIELD

The present invention relates to an optical waveguide element, an optical modulation device using the same, and an optical transmission apparatus, and in particular, to an optical waveguide element including an optical waveguide substrate having a rib-type optical waveguide formed of a material having an electro-optic effect and a holding member disposed at a position where an input end or an output end of the rib-type optical waveguide is formed, to overlap the optical waveguide substrate.

### BACKGROUND ART

In recent years, with an increase in information volume in the field of information communication, it is desired that not only optical communication for long-distance transmission but also optical communication used between cities or between data centers will become faster and larger. Moreover, due to a limited space of a base station, there is an increasing need for a broadband or a low drive voltage and a reduction in size of an optical modulator.

In particular, for the reduction in size of the optical modulator, an optical confinement effect of an optical waveguide is strengthened to reduce a bending radius of the optical waveguide, and for example, to bend directions of a light wave input to and a light wave output from an optical waveguide element at 90 degrees or 180 degrees, and the like, so that an optical modulator suitable for miniaturization can be manufactured. In strengthening the optical confinement effect and reducing bending loss, for example, miniaturization of the optical waveguide, such as setting a mode field diameter (MFD) of a propagating light wave to be equal to or lower than 3 μm, is effective.

Although LiNbO₃ (hereinafter, referred to as LN) having an electro-optic effect is used as an optical modulator for a long distance because of less distortion and less optical loss in converting an electrical signal into an optical signal, miniaturization has been difficult because the MFD of the conventional optical waveguide is about 10 μm and the bending radius is as large as several tens of millimeters. However, in recent years, LN can be thinned with improvement in polishing technique and bonding technique, and an LN optical waveguide element with an MFD of about 1 μm is being researched and developed.

On the other hand, an MFD of an optical fiber is about 10 μm, and in an optical waveguide element including a fine optical waveguide with an MFD of lower than 1 μm, both MFDs have as much as a 10-fold difference, causing a problem that coupling loss in a coupling portion becomes considerably larger. Although there is a method that attaches a lens for expanding an MFD to an element end portion, or the like, a lens that converts the MED from 1 μm to 10 μm by about 10 fold is impossible in terms of design, and to convert the MFD with the lens, the MFD in at least the element end portion needs to be equal to or higher than 3 μm.

A spot size converter (SSC) structure may be made by changing a shape of the optical waveguide near an input/output portion on the optical waveguide element, the MFD may expand to about 3 μm in the element, and the lens may be added to the coupling portion of the element and the optical fiber to convert the MFD to 10 μm. In a general SSC, as shown in Patent Literature Nos. 1 to 3, a tapered optical waveguide of which a width or a thickness expands in a two-dimensional or three-dimensional manner toward an end portion of the optical waveguide is used. Although the advantage of this method is that the design is simple, there is a limit to the design that can be used because widening of the optical waveguide induces multi-mode, so that this method is not suitable for the optical waveguide element.

A material different from the optical waveguide is used near the input/output portion on the optical waveguide element, and a spot size converter (SSC) structure with a comparatively small difference in refractive index between a core and a clad is made in the input/output portion on the element, so that the MFD can expand to about 3 μm in the element while induction of multi-mode can be suppressed. Note that, in a case where a constituent material of the SSC is an organic substance, there is a problem with reliability of light resistance, heat resistance, or the like, and furthermore, because the SSC structure is formed of a different material on the optical waveguide substrate, a process becomes complicated and there is also a problem with man-hours or yield.

### CITATION LIST

### Patent Literature

[Patent Literature No. 1] International Publication No. WO2012/042708
[Patent Literature No. 2] International Publication No. WO2013/146818
[Patent Literature No. 3] Japanese Patent No. 6369036

### SUMMARY OF INVENTION

### Technical Problem

An object to be achieved by the present invention is to solve the above-described problems and to provide an optical waveguide element that can suppress insertion loss related to coupling to an optical fiber or the like while achieving a reduction in size of an optical waveguide element, and has a SSC structure with high light resistance, heat resistance, or manufacturing efficiency. Another object is to further provide an optical modulation device using the optical waveguide element and an optical transmission apparatus.

### Solution to Problem

In order to solve the objects, an optical waveguide element of the present invention, an optical modulation device using the same, and an optical transmission apparatus have the following technical features.
(1) There is provided an optical waveguide element including an optical waveguide substrate having a rib-type optical waveguide formed of a material having an electro-optic effect, and a holding member that is disposed and fixed at a position where an input end or an output end of the rib-type optical waveguide is formed, to overlap the optical waveguide substrate, in which another optical waveguide with a mode field diameter greater than that of the rib-type optical waveguide is formed on a surface of the holding member facing the rib-type optical waveguide, and the optical waveguide substrate and the holding member are bonded through an adhesive layer.
(2) In the optical waveguide element according to (1), when the optical waveguide element is viewed in a plan view, an end portion of the rib-type optical waveguide is positioned inside the holding member.
(3) In the optical waveguide element according to (1) or (2), an end portion of the rib-type optical waveguide is tapered toward a tip end.
(4) In the optical waveguide element according to any one of (1) to (3), the mode field diameter of the optical waveguide formed in the holding member is equal to or higher than 3 μm.
(5) In the optical waveguide element according to any one of (1) to (4), a refractive index of the rib-type optical waveguide is greater than a refractive index of a core layer of the optical waveguide formed in the holding member.
(6) In the optical waveguide element according to any one of (1) to (5), the adhesive layer is made of an inorganic material.
(7) In the optical waveguide element according to any one of (1) to (6), a thickness of the adhesive layer is set to be equal to a height of the rib-type optical waveguide.
(8) In the optical waveguide element according to any one of (1) to (7), the rib-type optical waveguide is formed of a crystal of lithium niobate.
(9) In the optical waveguide element according to any one of (1) to (8), SiO₂ is contained in a core layer of the optical waveguide formed in the holding member.
(10) There is provided an optical modulation device, in which the optical waveguide element according to any one of (1) to (9) is housed in a case, and the optical modulation device includes an optical fiber that inputs a light wave to or outputs a light wave from the optical waveguide formed in the holding member.
(11) In the optical modulation device according to (10), the optical waveguide element includes a modulation electrode for modulating the light wave propagating through the optical waveguide, and an electronic circuit that amplifies a modulation signal to be input to the modulation electrode of the optical waveguide element is provided inside the case.
(12) There is provided an optical transmission apparatus including the optical modulation device according to (10) or (11), and an electronic circuit that outputs a modulation signal for causing the optical modulation device to perform a modulation operation.

### Advantageous Effects of Invention

The present invention can provide an optical waveguide element having a SSC structure because an optical waveguide element includes an optical waveguide substrate having a rib-type optical waveguide formed of a material having an electro-optic effect, and a holding member disposed and fixed at a position where an input end or an output end of the rib-type optical waveguide is formed, to overlap the optical waveguide substrate, in which another optical waveguide with a mode field diameter greater than that of the rib-type optical waveguide is formed on a surface of the holding member facing the optical waveguide, and the optical waveguide substrate and the holding member are bonded through an adhesive layer. Furthermore, because a manufacturing process in incorporating the SSC structure is simple, and is also suitable for a SSC structure using an inorganic material, light resistance or heat resistance of the SSC structure itself can be increased. In addition, it is possible to provide an optical modulation device using an optical waveguide element having such excellent effects and an optical transmission apparatus.

### BRIEF DESCRIPTION OF DRAWINGS

FIG. 1 is a perspective view showing an outline of a configuration of an optical waveguide element of the present invention.

FIG. 2 is a cross-sectional view showing an example of the optical waveguide element of the present invention along an optical waveguide.

FIG. 3 is a plan view showing disposition of each member in a case where the optical waveguide element of FIG. 2 is viewed in a plan view.

FIGS. 4A to 4C are diagrams showing an example of an optical waveguide substrate that is used in the optical waveguide element of the present invention.

FIGS. 5A and 5B are diagrams showing an example of a holding member that is sued in the optical waveguide element of the present invention.

FIG. 6 is a diagram illustrating a disposition relationship of the optical waveguide, the holding member, and the like on the optical waveguide substrate in the optical waveguide element of the present invention.

FIG. 7A is a cross-sectional view showing another example of an optical waveguide element of the present invention, and FIG. 7B is a plan view showing another example of an optical waveguide element of the present invention.

FIG. 8A is a cross-sectional view showing a comparative example with respect to the optical waveguide element of the present invention, and FIG. 8B is a plan view showing a comparative example with respect to the optical waveguide element of the present invention.

FIG. 9 is a plan view illustrating an optical modulation device and an optical transmission apparatus of the present invention.

### DESCRIPTION OF EMBODIMENTS

Hereinafter, an optical waveguide element of the present invention will be described in detail using a suitable example.

In the following description, while a structure of an end portion of an optical waveguide will be described mainly focusing on an output end, it is needless to say that an input end can also be configured in the same manner.

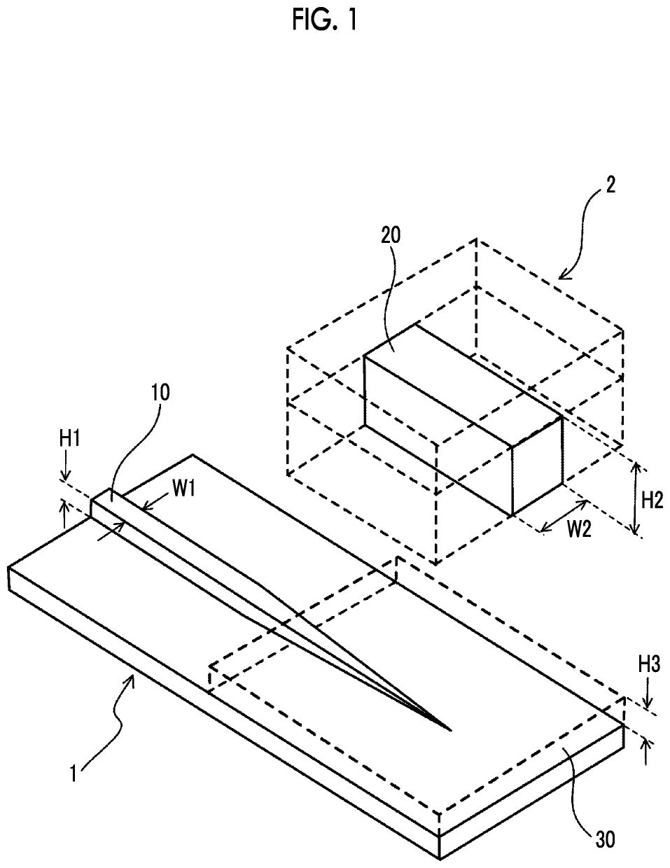

As shown in FIGS. 1 to 3, the optical waveguide element of the present invention includes an optical waveguide substrate 1 having a rib-type optical waveguide 10 formed of a material having an electro-optic effect, and a holding member 2 that is disposed and fixed at a position where an input end or an output end of the rib-type optical waveguide is formed, to overlap the optical waveguide substrate, in which another optical waveguide with a mode field diameter greater than that of the rib-type optical waveguide is formed on a surface of the holding member facing the rib-type optical waveguide, and the optical waveguide substrate and the holding member are bonded through an adhesive layer 30.

As the material constituting the optical waveguide that is used in the optical waveguide element of the present invention, a substrate of a ferroelectric material having an electro-optic effect, specifically, lithium niobate (LN), lithium tantalate (LT), lead lanthanum zirconate titanate (PLZT), or the like, an epitaxial film made of such materials, or the like can be used. Various materials, such as a semiconductor material or an organic material, can also be used as a substrate of the optical waveguide element.

A thickness H1 of the optical waveguide 10 that is used in the present invention is extremely thin to be equal to or smaller than 1 μm, and there is a method of mechanically polishing and thinning a crystal substrate, such as LN, or a method using an epitaxial film, such as LN. In a case of the epitaxial film, for example, the epitaxial film is formed by a sputtering method, a CVD method, a sol-gel method, or the like according to the crystal orientation of a single crystal substrate, such as a SiO₂ substrate, a sapphire single crystal substrate, or a silicon single crystal substrate.

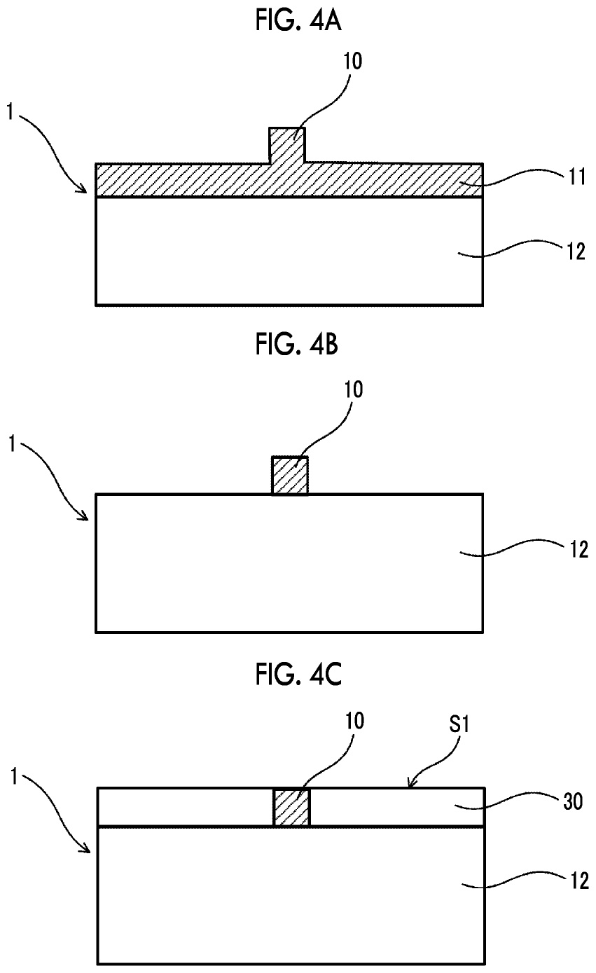

FIGS. 4A to 4C show an example of the optical waveguide substrate. As shown in FIG. 4A, because a thickness of a waveguide layer 11 including the optical waveguide 10 is thin, to increase mechanical strength of the optical waveguide element, a reinforcing substrate 12 is disposed on a back surface side of the waveguide layer 11. The reinforcing substrate 12 may be formed using a material, such as a SiO₂ substrate, with a refractive index lower than that of the waveguide layer 11 (optical waveguide 10). In a case where a material, such as a Si substrate, with a refractive index higher than that of the waveguide layer 11 (optical waveguide 10) is used as the material of the reinforcing substrate 12, it is necessary to form an intermediate layer made of a material with a refractive index lower than that of the waveguide layer 11 (optical waveguide 10) between layers of the reinforcing substrate 12 and the waveguide layer 11 (optical waveguide 10) such that waveguide light is sufficiently confined in the waveguide layer 11 (optical waveguide 10). In bonding the waveguide layer 11 and the reinforcing substrate 12, direct bonding or a method of bonding using an adhesive can also be used. As shown in FIG. 4B, the reinforcing substrate 12 may be used as a base of crystal growth, and a layer constituting the optical waveguide 10 of the epitaxial film may be provided.

As a method for forming a rib-type protrusion constituting the optical waveguide 10, a method of forming the protrusion by dry or wet etching a layer (for example, an LN layer) forming the optical waveguide can be used. In addition, in order to increase the refractive index of the rib portion, a method of thermally diffusing a high refractive index material, such as Ti, to the position of the rib portion can also be used together.

A main feature of the optical waveguide element of the present invention is that, as shown in FIGS. 1 to 3, another optical waveguide 20 with a mode field diameter greater than that of the optical waveguide 10 of the optical waveguide substrate 1 is provided in a holding member that is attached to the optical waveguide substrate 1, and is given a SSC function.

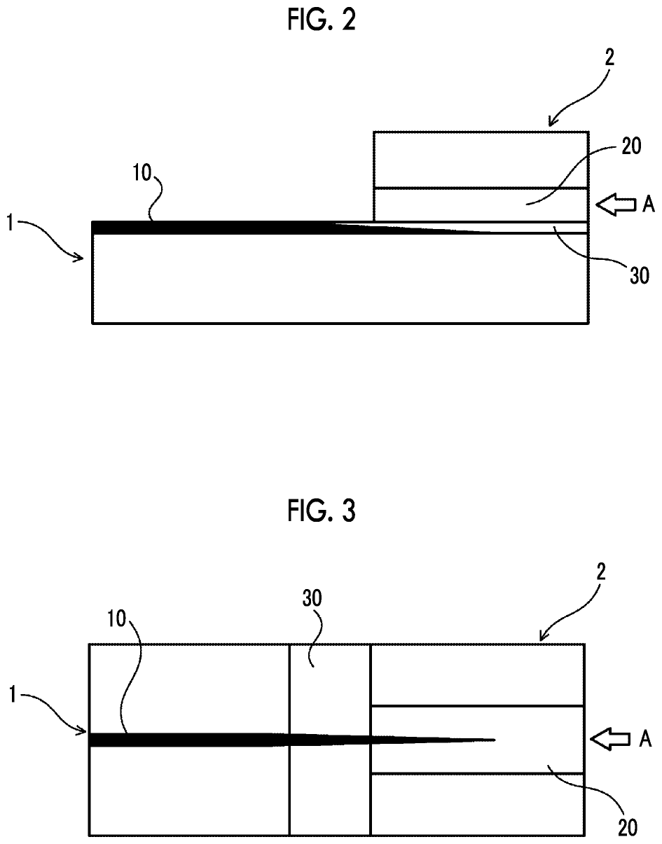

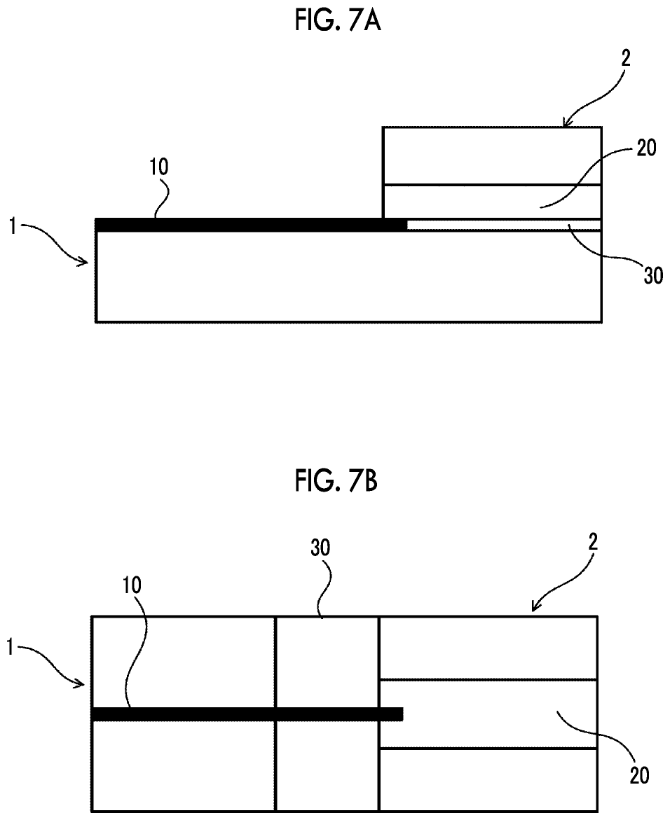

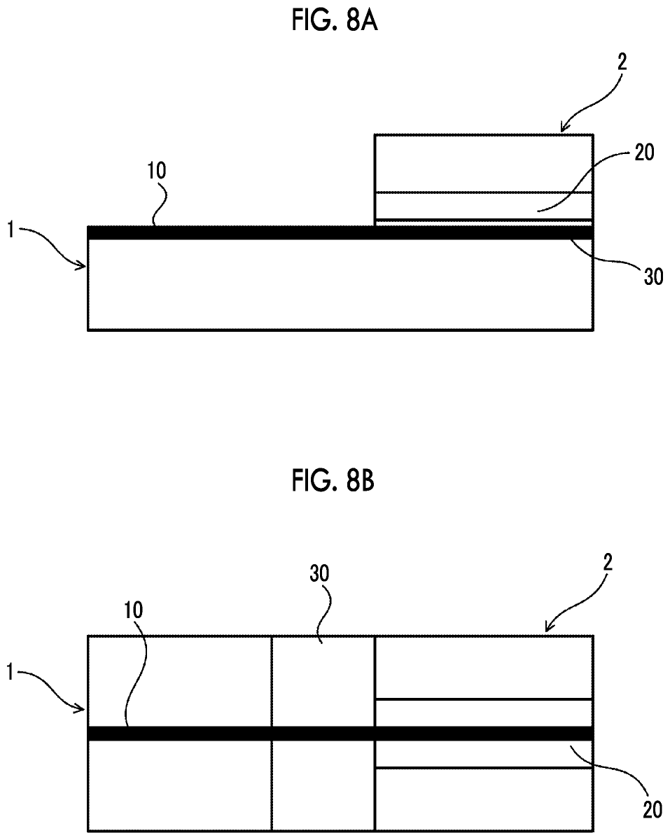

FIG. 1 is a perspective view showing a state before the optical waveguide substrate 1 and the holding member 2 are bonded by the adhesive layer 30, and FIG. 2 is a cross-sectional view showing a state in which both are bonded, along the optical waveguide 10. FIG. 3 is a plan view of FIG. 2, and is drawn like a perspective view such that a disposition relationship of the optical waveguide 10 of the optical waveguide substrate 1, the optical waveguide (core layer) 20 of the holding member 2, and further, the adhesive layer 30 is clearly understood. The same also applies to FIGS. 7A and 7B and FIGS. 8A and 8B described below.

Normally, the holding member 2 is superimposed and bonded onto the optical waveguide substrate along a substrate end surface where there is an input and output portion of a light wave of the optical waveguide substrate 1. This is not only to increase mechanical strength of an end surface side of the substrate, but also to facilitate bonding of a lens or an optical fiber to the substrate end surface. The lens or the optical fiber is bonded to a position of a white arrow A of FIGS. 2 and 3. The present invention easily realizes an optical waveguide element with a SSC function merely through a simple operation of attaching the holding member 2 to the optical waveguide substrate 1 by incorporating the SSC structure in the holding member.

As shown in FIGS. 1 to 3, the above-described rib-type optical waveguide 10 is formed on the optical waveguide substrate 1 that is in charge of a part of the SSC structure, and has a tapered shape toward an end portion (input end or output end) of the optical waveguide. The shape of the end portion of the optical waveguide 10 is not limited to the tapered shape, and as described below, a shape having constant width W1×thickness H1 to a termination may be made, but a test conducted by the present inventors shows that the tapered shape has low optical coupling loss. Although the tapered shape of FIG. 1 employs a configuration in which both the width and the thickness of the optical waveguide 10 are gradually narrowed, a shape in which only one of the width and the thickness is decreased may be employed.

In the holding member 2, the optical waveguide 20 composed of a core layer (20) and a clad layer is formed on a bonding surface side to the optical waveguide substrate 1, and the optical waveguide 20 has a function as a SSC.

In regard to a relationship of refractive indexes in respective parts, in a case where the refractive indexes of the respective parts are defined as follows, a relationship of Expression 1 and/or Expression 2 is established.
n1 . . . refractive index of rib-type optical waveguide 10 on optical waveguide substrate 1
n2 . . . refractive index of adhesive layer 30
n3 . . . refractive index of core layer of SSC formed in holding member
n4 . . . refractive index of clad layer of SSC formed in holding member

As a lowest level of condition, n1>n3>n4 (Expression 1) is satisfied.

The refractive index n2 of the adhesive layer generally has a relationship of n1>n2 >n3 (Expression 2), and a difference in refractive index between n2 and n3 may be set to about 0 to 0.05. A thickness H3 of the adhesive layer may be set to be smaller than 1 μm. For the adhesive layer, an inorganic material, such as a mixture of SiO₂ and inorganic oxide, is used. In a case where adhesive strength is insufficient, an intermediate layer may be added. In particular, in a case where a thickness of the intermediate layer is smaller than 50 nm, a refractive index of the intermediate layer is not limited to the above expression.

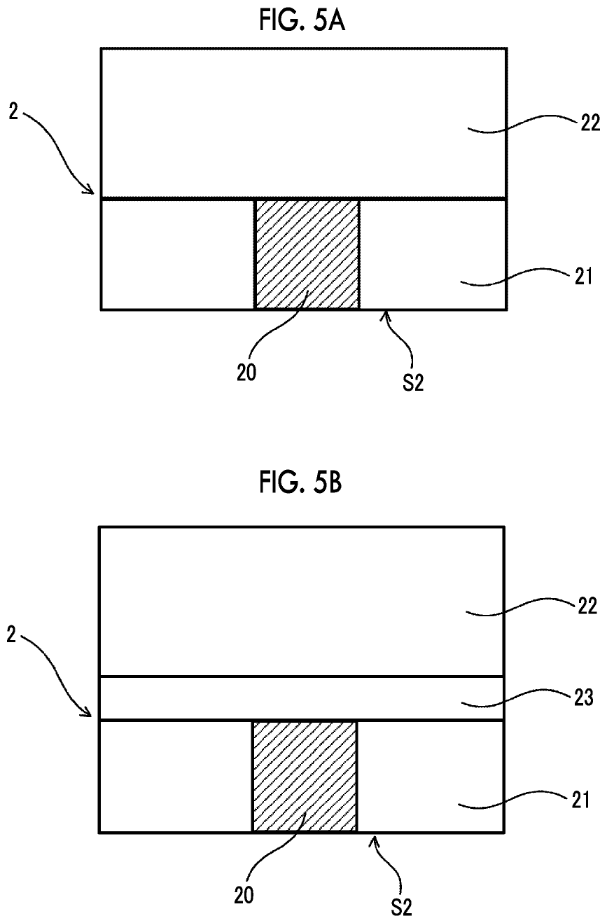

FIGS. 5A and 5B are diagrams of the holding member 2 as viewed from a traveling direction of a light wave, and in FIG. 5A, a core layer 20 and a clad layer 21 are formed on a holding base material 22 constituting the holding member. In this case, the holding base material 22 also functions as a clad layer. In FIG. 5B, a layer to be a clad layer 23 is formed on the holding base material 22, and the core layer 20 and the clad layer 21 are formed on the clad layer 23.

Although a rectangular parallelepiped shape of which a width W2 and a thickness H2 are constant is illustrated as a shape of the core layer 20, the shape of the core layer 20 is not limited to the rectangular parallelepiped shape, for example, a shape in which the width W2 and the thickness H2 are gradually widened toward an input end or an output end of a light wave.

For the holding base material, the core layer, and the clad layer, an inorganic material is used. SiO₂ may be contained in the core layer. As a material constituting the holding member, from a viewpoint of temperature characteristic improvement of the optical waveguide element, the same material as the reinforcing substrate 12 or a material having a linear expansion coefficient close to the reinforcing substrate 12 is suitably used.

The optical waveguide 10 of the optical waveguide substrate 1 is W1≤1 μm and H1≤1 μm, and has the MFD equal to or lower than 1 μm, and on the other hand, the optical waveguide (core layer) 20 of the holding member is W2≥3 μm and H2≥3 μm, and has the MFD equal to or higher than 3 μm.

A maximum MFD of the optical waveguide (core layer) 20 of the holding member is set to about 7 μm, so that it is possible to suppress an increase in optical coupling loss of the optical waveguide 10 of the optical waveguide substrate 1 and the optical waveguide 20 of the holding member 2.

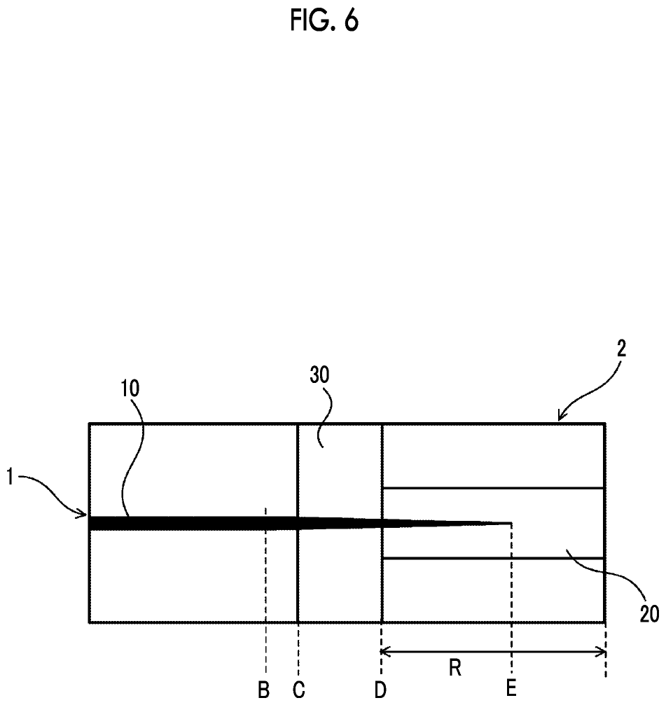

FIG. 6 shows the disposition of the rib-type optical waveguide 10 in a case where the optical waveguide substrate 1 and the holding member 2 are superimposed. A position of a dotted line B is a position where the tapered shape of the optical waveguide 10 starts, and a dotted line E is a tip end position of the optical waveguide 10. As a lowest level of condition, the position of the dotted line E may be positioned within a range R of a length of the optical waveguide 20 of the holding member 2. An end portion position C of the adhesive layer 30 may protrude inside the substrate 1 with respect to the end portion position D of the holding member. The position of the dotted line B may be closer to the dotted line d side than the dotted line C or may be on the left side of FIG. 6 farther than the dotted line D.

In the following examples, a case shown in FIGS. 7A and 7B where the rib-type optical waveguide 10 maintains constant width and thickness, and terminates in the middle of the holding member 2 is also shown.

### EXAMPLES

Hereinafter, a manufacturing method and a test result of an optical waveguide element practically created will be described.

### (Formation of Optical Waveguide for SSC in Holding Member)

Germanium tetrachloride (GeCl₄) and glass raw material gas (SiCl₄) are sprayed onto SiO₂ glass as a holding base material at an arbitrary ratio by a flame hydrolysis deposition method, a glass material composed of GeO₂ and SiO₂ is formed at a thickness equal to or greater than 5 μm, and the glass material is used as an upper clad layer (reference numeral 23 of FIG. 5B) of an optical waveguide for a SSC.

Next, another glass material of which a refractive index is adjusted to be higher than that of the clad layer by changing a GeCl₄ content is formed as a core layer in the same manner by a flame hydrolysis deposition method. Thereafter, a core circuit is formed by lithography, reactive ion etching, or the like. After circuit formation, a lower clad layer is deposited on the core to have a thickness equal to or greater than a core height in the same method as the upper clad. Then, polishing is performed by chemical-mechanical polishing (CMP) or the like until the core layer is exposed on the surface, a bonding surface S2 of FIGS. 5A and 5B is formed, and a holding member with a SSC function is obtained.

Four types of holding members with a SSC function (see Table 2) are manufactured using glass materials A to F (see Table 1) in which a refractive index is changed by adjusting a ratio of GeO₂ and SiO₂. A core size of each of the holding members is a maximum size of which single-mode light can be guided on simulation. For comparison, a holding member formed from only a holding base material with no SSC function is also prepared.

TABLE 1
GeO2:SiO2 Ratio and Refractive Index of Glass Material

| Glass | | | | | | |
|---|---|---|---|---|---|---|
| Material | A | B | C | D | E | F |
| GeO2 (vol %) | 0.617 | 0.456 | 0.363 | 0.425 | 0.233 | 0.254 |
| SiO2 (vol %) | 0.383 | 0.544 | 0.637 | 0.575 | 0.767 | 0.746 |
| Refractive | 1.576 | 1.545 | 1.527 | 1.539 | 1.502 | 1.506 |
| Index | | | | | | |

TABLE 2
Configuration of Holding Member With SSC Function

| | | Holding | Holding | Holding | Holding | Holding |
|---|---|---|---|---|---|---|
| | | Member 1 | Member 2 | Member 3 | Member 4 | Member 5 |
| Clad | Material | Glass | Glass | Glass | Glass | Only Holding |
| | | Material C | Material B | Material E | Material F | Base Material |
| | Refractive | 1.527 | 1.545 | 1.502 | 1.506 | (SiO2 glass) |
| | Index | | | | | |
| Core | Material | Glass | Glass | Glass | Glass | |
| | | Material A | Material A | Material D | Material C | |
| | Refractive | 1.576 | 1.576 | 1.539 | 1.527 | |
| | Index | | | | | |
| | Size | 3 × 3 | 5 × 5 | 4 × 4 | 6 × 6 | |
| | W × H (μm) | | | | | |

| | | | | | |
|---|---|---|---|---|---|
| Refractive Index | 0.049 | 0.031 | 0.037 | 0.021 | — |
| Difference Δ | | | | | |

### (Formation of Optical Waveguide Substrate)

For an optical waveguide substrate, as shown in FIG. 4A, an LN thin plate 11 on which a linear rib-type optical waveguide is formed is attached onto the reinforcing substrate 12 composed of SiO₂ glass is used. The rib-type optical waveguide 10 is set to 1 μm×1 μm. The MFD of the waveguide is 1 μm. In regard to the shape of the optical waveguide 10 of a portion bonded to the holding member, three types of an optical waveguide substrate a in which, as shown in FIGS. 1 to 3, an optical waveguide portion has a tapered shape toward a coupling end surface and a tapered portion disappears in a bonded portion to the holding member 2 with a SSC function, an optical waveguide substrate b in which, as shown in FIGS. 7A and 7B, the rib-type optical waveguide 10 maintains the same shape to the bonded portion to the holding member 2 with a SSC function and disappears in the bonded portion, and an optical waveguide substrate c in which, as shown in FIGS. 8A and 8B, the rib-type optical waveguide maintains the same shape to the element end surface are manufactured.

(Bonding of Optical Waveguide Substrate and Holding Member with SSC Function)

For a portion in the optical waveguide substrate bonded to the holding member, four types of adhesive layers shown in Table 3 are prepared. The material of each of three types of adhesive layer (1) to (3) among the four types adhesive layers is deposited at a thickness of 0.5 μm, the surface is smoothed by CMP or the like, and the optical waveguide substrate 1 having the bonding surface S1 shown in FIG. 4C is obtained. As in FIG. 4C, the thickness of the adhesive layer 30 is set to be equal to the height of the rib-type optical waveguide 10, so that it is possible to secure smoothing of the bonding surface.

In regard to “glass material A” and “glass material D” of Table 3, the corresponding glass materials of Table 1 are formed by a flame hydrolysis deposition method, and an adhesive layer of “Ta₂O₅” is formed by sputtering.

Thereafter, the processed optical waveguide substrate and a holding substrate are put in a bonding chamber such that bonding surfaces face each other at a predetermined clearance, and the inside of the chamber is brought into a vacuum state. After a predetermined degree of vacuum is reached, the bonding surfaces (S1 and S2) are irradiated with an Ar ion beam, and the bonding surfaces in the optical waveguide substrate and the holding substrate are activated. Thereafter, both substrates are closely attached to bond the substrates, and the optical waveguide substrate and the holding substrate with a SSC function are integrated.

TABLE 3
Adhesive Layer Material

| | Adhesive | Adhesive | Adhesive | Adhesive |
|---|---|---|---|---|
| | Layer | Layer | Layer | Layer |
| | (1) | (2) | (3) | (4) |
| Material | Glass | Glass | Ta₂O₅ | E3754 |
| | Material A | Material D | | (Epoxy Resin |
| | | | | manufactured |
| | | | | by NTT-AT |
| | | | | Corporation) |
| Refractive | 1.576 | 1.539 | 2.160 | 1.577 |
| Index | | | | |

### (Evaluation Results)

The “holding member with a SSC function” and the “optical waveguide substrate” produced by the above-described method are bonded through the “adhesive layer” of Table 3, and the optical waveguide element is produced. A combination of respective members and evaluation results of characteristics of the optical waveguide elements are shown in Table 4. In characteristic evaluation, evaluation is made with measurement of an MED in the element end surface and a difference in loss after light of 20 dBm is input and the optical waveguide element is held at 85° C. for 2000 hr.

TABLE 4
Evaluation Result

| | Example | Example | Example | Example | Example | Example | Example | Comparative | Comparative | Comparative |
|---|---|---|---|---|---|---|---|---|---|---|
| | 1 | 2 | 3 | 4 | 5 | 6 | 7 | Example 1 | Example 2 | Example 3 |
| Holding | 1 | 1 | 2 | 3 | 4 | 1 | 1 | 5 | 5 | 1 |
| Member | | | | | | | | | | |
| Optical | a | b | a | a | a | a | a | a | c | c |
| Waveguide | | | | | | | | | | |
| Substrate | | | | | | | | | | |
| Adhesive | 1 | 1 | 1 | 2 | 1 | 3 | 4 | 1 | 1 | 1 |
| Layer | | | | | | | | | | |
| MFD | 3.0 | 3.0 | 5.4 | 4.1 | 6.7 | 3.0* | 2.9 | C | 1.0 | 1.0 |
| (μm) | | | | | | | | | | |
| Loss | A | A | A | A | A | A | B | — | A | A |
| Change | | | | | | | | | | |
| Amount | | | | | | | | | | |

Loss Change Amount: in a case of Loss before and after load test ≤ 1.0 dB, A, in a case of Loss before and after load test 1.0 to 2.0 dB, B, and in a case of Loss before and after load test > 2.0 dB, C.
*indicates that light is single-mode light and is not guided.

In comparison of Examples 1 to 7 and Comparative Examples 2 and 3, it is understood that, in expanding the MFD, the rib-type optical waveguide 10 of the optical waveguide substrate needs to disappear in the bonding surface to the holding member with a SSC function. In particular, in a case where the rib-type optical waveguide 10 extends to an end surface (for example, an end surface where coupling to an optical fiber is performed) of the optical waveguide element, light that is guided through the optical waveguide is not transferred to the SSC of the holding member, and the SSC function cannot be exhibited (see Comparative Example 3).

In a case where the rib-type optical waveguide disappears in the bonding surface to the holding member with a SSC function, in both the tapered optical waveguide substrate a and the rectangular optical waveguide substrate b, light can be transferred to the SSC structure of the holding member, and the MFD can be expanded (in particular, see Examples 1 and 2).

Note that, like the optical waveguide substrate b, in a structure in which change in shape is considerable in the end surface of the rib-type optical waveguide 10, because coupling loss becomes greater in a portion where light is transferred to the SSC from a portion where the optical waveguide disappears, a structure having gradual change in shape like the optical waveguide substrate a may be employed. In a case of the shape of the optical waveguide substrate a, the rib-type optical waveguide 10 may be tapered after being bonded to the holding member with a SSC function or may be tapered before bonding.

From the above, because the optical waveguide element of the present invention can give a SSC structure merely by bonding the optical waveguide substrate and the holding member, the holding member can be manufactured in a line different from a manufacturing line of the optical waveguide element, a manufacturing process can be simplified, and manufacturing efficiency can be increased.

Furthermore, because the material constituting the SSC structure can also be composed only of an inorganic material, high light resistance or heat resistance is achieved.

Next, an optical modulation device and an optical transmission apparatus using the optical waveguide element of the present invention will be described.

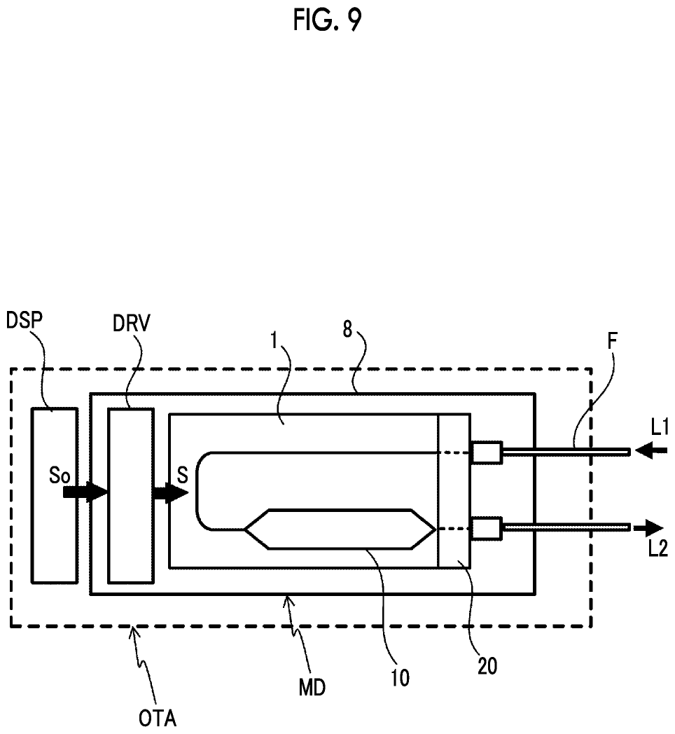

In the above-described optical waveguide element, a modulation electrode that modulates a light wave propagating through the optical waveguide 10 is provided and is housed in a case 8 as shown in FIG. 9. In addition, an optical fiber F through which a light wave is input to and output from the optical waveguide is provided, so that an optical modulation device MD can be configured. In FIG. 9, the optical fiber is introduced into the case through a through-hole penetrating a side wall of the case and directly bonded to the optical waveguide element. The optical waveguide element and the optical fiber can also be optically connected through a space optical system.

An optical transmission apparatus OTA can be configured by connecting, to the optical modulation device MD, an electronic circuit (digital signal processor DSP) that outputs a modulation signal for causing the optical modulation device MD to perform a modulation operation. Because the modulation signal that is applied to the optical waveguide element needs to be amplified, a driver circuit DRV is used. The driver circuit DRV or the digital signal processor DSP may be disposed outside the case 8 or may be disposed in the case 8. In particular, the driver circuit DRV is disposed in the case, so that propagation loss of the modulation signal from the driver circuit can be further reduced.

### INDUSTRIAL APPLICABILITY

As described above, according to the present invention, it is possible to provide an optical waveguide element that can suppress insertion loss related to coupling to an optical fiber or the like while achieving a reduction in size of an optical waveguide element, and has a SSC structure with high light resistance, heat resistance, or manufacturing efficiency. Furthermore, it is possible to provide an optical modulation device using the optical waveguide element and an optical transmission apparatus.

### REFERENCE SIGNS LIST

1 optical waveguide substrate
2 holding member
10 rib-type optical waveguide
20 optical waveguide (core layer) formed in holding member
30 adhesive layer
MD optical modulation device
OTA optical transmission apparatus

1. An optical waveguide element comprising:
an optical waveguide substrate having a rib-type optical waveguide formed of a material having an electro-optic effect; and
a holding member that is disposed and fixed at a position where an input end or an output end of the rib-type optical waveguide is formed, to overlap the optical waveguide substrate, wherein another optical waveguide with a mode field diameter greater than that of the rib-type optical waveguide is formed on a surface of the holding member facing the rib-type optical waveguide, and
the optical waveguide substrate and the holding member are bonded through an adhesive layer.

2. The optical waveguide element according to claim 1,
wherein, when the optical waveguide element is viewed in a plan view, an end portion of the rib-type optical waveguide is positioned inside the holding member.

3. The optical waveguide element according to claim 1,
wherein an end portion of the rib-type optical waveguide is tapered toward a tip end.

4. The optical waveguide element according to claim 1,
wherein the mode field diameter of the optical waveguide formed in the holding member is equal to or higher than 3 μm.

5. The optical waveguide element according to claim 1,
wherein a refractive index of the rib-type optical waveguide is greater than a refractive index of a core layer of the optical waveguide formed in the holding member.

6. The optical waveguide element according to claim 1,
wherein the adhesive layer is made of an inorganic material.

7. The optical waveguide element according to claim 1,
wherein a thickness of the adhesive layer is set to be equal to a height of the rib-type optical waveguide.

8. The optical waveguide element according to claim 1,
wherein the rib-type optical waveguide is formed of a crystal of lithium niobate.

9. The optical waveguide element according to claim 1,
wherein SiO2 is contained in a core layer of the optical waveguide formed in the holding member.

10. An optical modulation device,
wherein the optical waveguide element according to claim 1 is housed in a case, and
the optical modulation device comprises:
an optical fiber that inputs a light wave to or outputs from the optical waveguide formed in the holding member.

11. The optical modulation device according to claim 10,
wherein the optical waveguide element includes a modulation electrode for modulating the light wave propagating through the optical waveguide, and
an electronic circuit that amplifies a modulation signal to be input to the modulation electrode of the optical waveguide element is provided inside the case.

12. An optical transmission apparatus comprising:
the optical modulation device according to claim 10; and
an electronic circuit that outputs a modulation signal for causing the optical modulation device to perform a modulation operation.
